(19) United States
(12) Patent Application Publication
(10) Pub. No.: US 2005/0115894 A1
(43) Pub. Date: Jun. 2, 2005

(54) Method of treating sewage

(76) Inventors: Norman Thomas Jennings, Rouse Hill (AU); Darryl Ugo Jennings, Rouse Hill (AU); Garry Gordon Jennings, Rouse Hill (AU); Ernest S. Manley, Gleenwood (AU)

Correspondence Address: FAY KAPLUN & MARCIN, LLP, Suite 702, 150 Broadway, New York, NY, 10038, US

(21) Appl. No.: 10/954,038

(22) Filed: Sep. 29, 2004

Related U.S. Application Data
(63) Continuation-in-part of application No. 10/903,054, filed on Jul. 30, 2004.
Application No. 10/903,054 is a continuation-in-part of application No. 10/020,309, filed on Dec. 14, 2001, now Pat. No. 6,827,855.

(30) Foreign Application Priority Data
Dec. 15, 2000 (AU) PR2115

(51) Int. Cl. C02F 3/32

(52) U.S. Cl. 210/602

(57) ABSTRACT

A system for producing fishmeal from sewage includes three main facilities: a hatchery, a system of treated sewage maturation ponds and a fish processing plant. Each of hatchery, plant ponds and plant occupy respective sites; all of which are disposed adjacent or near to each of the others. The commencement and end of the cycle of the processing at each of the facilities in system are synchronised.

### PRIORITY CLAIM

The present application is a Continuation-In-Part of the U.S. patent application Ser. No. 10/903,054 filed Jul. 30, 2004, entitled “METHOD OF TREATING SEWAGE”, which is a Continuation-In-Part of the U.S. application Ser. No. 10/020,309 filed Dec. 14, 2001, entitled “METHOD OF TREATING SEWAGE”, which claims priority from Australian Patent Application No. PR2115 filed Dec. 15, 2000. The Specifications of these applications are expressly incorporated herewith by reference.

### FIELD OF THE INVENTION

The present invention relates to a method of treating sewage and a sewage treatment system.

### BACKGROUND TO THE INVENTION

The disposal of human and animal waste is a large problem facing the world community, particularly in locations where population densities are high. In some cases, it is common practice, or at least known, to pump untreated or primary treated sewage into natural waterways or, for coastal cities, the adjacent ocean. Clearly this is an undesirable and unsustainable long-term solution.

In those locations that utilise secondary and tertiary treatment plants for processing the sewage, there are ongoing issues of cost and efficiency. These plants are large in area, are expensive to run, take considerable time to process the sewage, and consume large amounts of energy. Moreover, the improvement or expansion of such plants to cater for growth in populations is extremely capital intensive and can usually only be countenanced by taking a long term approach to seeing a financial return on that capital.

With the increased reluctance to invest more capital in expansion of the treatment plants, those plants are usually run at or near capacity. This increases the risk of accidental releases of raw or partially treated sewage into the waterways downstream of the plant. That, in turn, increases the risk of health concerns for those using those waterways and for the general health of the waterway itself. For example, raw or partially treated sewage is thought to contribute to algae blooms and other undesirable affects in river systems, and to the destruction of the seabed and the natural coastal fish nurseries. In other cases, untreated or partially treated sewage is thought to contribute to increased rates of illness amongst beach goers.

Any discussion of the prior art throughout the specification should in no way be considered as an admission that such prior art is widely known or forms part of common general knowledge in the field.

### SUMMARY OF THE INVENTION

It is an object of the present invention, at least in a preferred embodiment, to overcome or substantially ameliorate one or more of the disadvantages of the prior art or at least provide a useful alternative.

According to a first aspect of the invention there is provided a method for producing fishmeal from sewage, the method comprising the steps of:
introducing the sewage into a holding tank;
releasing live fish into the holding tank to consume and process the sewage;
removing the fish from the holding tank; and
processing the fish to produce the fishmeal, wherein the processing step includes the substeps of:
segmenting the fish into pieces;
drying the fish;
combining the pieces with additives to form one of a paste and a powder.

In an embodiment, the substep of segmenting includes cutting the fish into the pieces. In another embodiment, the substep of segmenting includes grinding the fish into pieces. In another embodiment, the substep of segmenting includes shredding the fish into pieces.

In an embodiment, the substep of drying the fish includes cooking the fish.

In an embodiment, the moisture content of the paste is about 10% to 15%. More preferably, the moisture content of the paste is about 11% to 13%. Even more preferably, the paste or powder is extruded into pellets wherein, prior to the extruding, the moisture content is varied by addition of water to the paste or powder or, alternatively, by drying the paste or powder.

In an embodiment, the pieces of fish are less than or about 1 cm³. However, in other embodiments, the pieces of fish are a different size and, more preferably, smaller than 1 cm³.

In an embodiment, the combining of the pieces of fish with the additives includes agitating the pieces of fish both to encourage intermingling of the pieces with the additives and to further break down the pieces into smaller pieces.

In an embodiment, the additives are chosen in response to the end use of the fishmeal. For example, in some embodiments the additives are grains and, more preferably one or more cereal grains such as wheat, soybean and barley. In some embodiments, the additives are a meal made from one or more of those grains.

According to a second aspect of the invention there is provided a method for treating sewage, the method including:
processing the sewage with a primary or secondary sewage treatment;
directing the processed sewage into a holding tank;
releasing live fish into the holding tank to consume and otherwise process the sewage; and
removing the fish from the tank.

Preferably, the fish are removed from the tank at a predetermined period after being released into the tank. However, in other embodiments, the fish are removed from the tank when they are of a predetermined size or weight. More preferably, the predetermined size or weight is based upon an average size or weight. In some embodiments the fish are released into the tank simultaneously and removed from the tank progressively.

Preferably, the fish are European carp and the predetermined period is within the range of about fifty days to ninety days. More preferably, the predetermined period is within the range of about sixty days to eighty five days. Even more preferably, the predetermined period is within the range of about seventy days to eighty days. In one of the preferred embodiment described below, the predetermined period is consistently about seventy seven days.

In other embodiments different species of fish are used. For example, in one alterative embodiment, the fish are Tilapia.

Preferably also, the holding tank includes a plurality of sub-divisions through which the sewage is directed and the method includes the step of releasing live fish into each sub-division and subsequently harvesting the live fish from respective sub-divisions. More preferably, the method includes the step of sequentially releasing live fish into each sub-division. More preferably, the method includes the step of harvesting the live fish from respective sub-divisions in accordance with the sequence of the release of the fish.

In a preferred form, the method includes the step of progressively directing the sewage to the tank. More preferably, the method includes the step of directing the sewage into the tank at a predetermined rate. In some embodiments, the predetermined rate varies with time.

According to a third aspect of the invention there is provided a sewage treatment system including a plurality of interlinked holding tanks for receiving sewage and for containing live fish to consume and otherwise process the sewage.

According to a fourth aspect of the invention there is provided a method for producing fishmeal from sewage, the method comprising the steps of:
growing over a predetermined period a given biomass of live fingerlings;
introducing the sewage into a holding tank;
releasing the fingerlings into the holding tank to consume and process the sewage and to grow into fish;
removing the fish from the holding tank after about one or more integral multiples of the predetermined period following their release into the tank; and
processing the fish to produce the fishmeal.

Preferably, the fish are removed from the holding tank after about one predetermined period.

According to a fifth aspect of the invention there is provided a method for producing pet food from sewage, the method comprising the steps of:
introducing the sewage into a holding tank;
releasing live fish into the holding tank to consume and process the sewage;
removing the fish from the holding tank;
freezing the fish; and
processing the fish to produce the pet food.

Preferably, the live fish, upon release into the holding tank, are fingerlings. More preferably, the method includes the step of growing over a predetermined period a given biomass of the fingerlings. More preferably, the step of removing the fish from the holding tank occurs after about one or more integral multiples of the predetermined period following their release into the tank.

According to a sixth aspect of the invention, there is provided pet food derived from the process according to the fifth aspect.

According to a seventh aspect of the invention there is provided a method for producing mollusc feed from sewage, the method comprising the steps of:
introducing the sewage into a holding tank;
releasing live fish into the holding tank to consume and process the sewage;
removing the fish from the holding tank;
processing the fish to produce fishmeal processing the fishmeal to produce mollusc feed

Preferably, the live fish, upon release into the holding tank, are fingerlings. More preferably, the method includes the step of growing over a predetermined period a given biomass of the fingerlings. More preferably, the step of removing the fish from the holding tank occurs after about one or more integral multiples of the predetermined period following their release into the tank.

Preferably, the step of processing the fishmeal to produce mollusc feed includes the steps of:
combining the fishmeal with additives to produce an intermediate product;
controlling the moisture content of the intermediate product; and
extruding the intermediate product to produce mollusc feed having a density higher than a predetermined density.

Preferably, the predetermined density is that of water. More preferably, the mollusc feed is for consumption by molluscs contained in a liquid, and the predetermined density is the density of the liquid.

According to an eighth aspect of the invention, there is provided mollusc feed derived from the process according to the seventh aspect.

The term “sewage” is intended in this specification and claims to include animal and/or human waste that is of one or more of a solid, semi solid and liquid form. Depending upon the context, that term also includes the water and/or other fluid that has been added to the waste to facilitate its passage through a sewer system. In some embodiments, additional water or fluid is added to the sewage while, in other embodiments, that is not required. For example, in the treatment of human waste, there is usually sufficient fluid, in the form of water, already part of the sewage. That water is added at the source of the sewage to facilitate the progression of the sewage through the sewer system and to the relevant treatment site. For animal waste, such as that generated in piggeries, it is often necessary to add additional fluid, usually water, to assist in the processing provided by the invention.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

### BRIEF DESCRIPTION OF THE DRAWINGS

Preferred embodiments of the invention will now be described, by way of example only, with reference to the accompanying drawings in which:

FIG. 1 is a schematic plan view of two holding tanks for use with one embodiment of the invention;

FIG. 2 is a schematic cross section through the tanks of FIG. 1;

FIG. 3 is a schematic view of an alternative embodiment of the invention;

FIG. 4 is a schematic top view of pond system of FIG. 3;

FIG. 5 is a schematic view of a system for processing fish to produce fishmeal according to another embodiment of the invention;

FIG. 6 is a schematic view of the hatchery of FIG. 5;

FIG. 7 is a schematic view of a transportation container for assisting in the transfer of animals between the hatchery of FIG. 5 and the sewage treatment plant of FIG. 9;

FIG. 8 is a side view of a cage that, in use, is disposed within the container of FIG. 7;

FIG. 9 is a schematic view of the sewage treatment plant of FIG. 5;

FIG. 10 is a schematic view of the processing plant of FIG. 5;

FIG. 11 is a schematic view of an alternative processing plant;

FIG. 12 is a schematic view of a system for processing fish to produce pet food according to another embodiment of the invention;

FIG. 13 is a schematic view of a system for processing fish to produce mollusc feed according to another embodiment of the invention; and

FIG. 14 is a schematic view of the processing plant of FIG. 13.

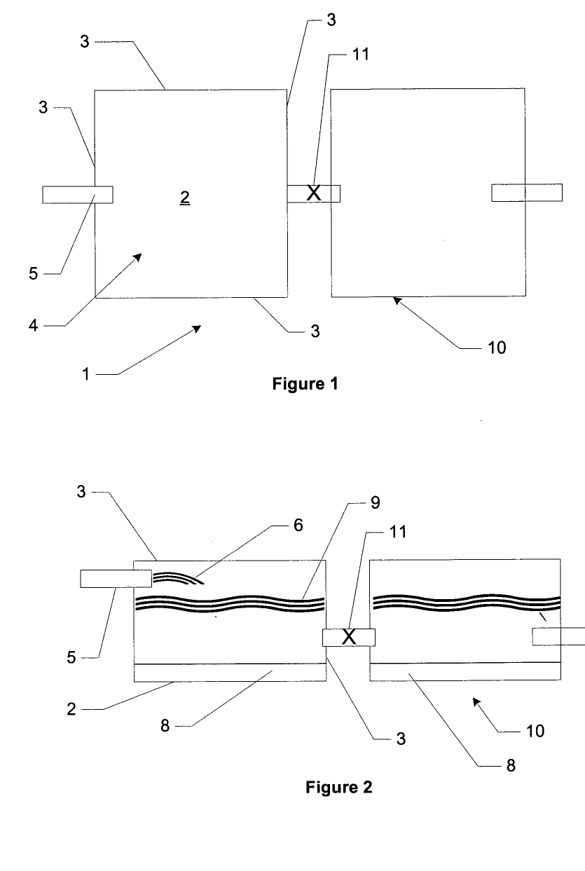

### DETAILED DESCRIPTION

Referring to the drawings, a first holding tank 1 includes a base 2 and a plurality of sidewalls 3 extending upwardly from the base to define an open top 4. An inlet pipe 5 provides sewage 6 into tank 1. While not shown, it will be appreciated that tank 1 is part of a sewage treatment plant comprised of six like sequentially interlinked tanks. In other embodiments, use is made of a different number of tanks.

Tank 1 has an average depth of about 1½ metres and a surface area of about 60 hectares. In other embodiments alternative depths and surface areas are used.

As will be appreciated by those skilled in the art, the sewage contains a certain amount of fluid, in the form of liquid waste, as well as water to ensure the more solid matter travels through the sewerage pipes to the treatment plant. In some embodiments the amount of water contained within the sewerage is sufficient, while in other embodiments more water is added to dilute the sewage for optimum processing. This additional water is often required to reduce the concentration of certain elements such as nitrogen.

After a predetermined volume of sewage and other fluids are contained within tank 1 the inflow is halted and a number of live fish are introduced into tank 1. In this embodiment use is made of European carp or the like which are sufficiently robust to not only survive in the sewage and water mix, but are able to consume sewage and derive sufficient nutrients from this. That is, the fish allow the conversion of the sewage into fish manure that progressively builds up on the bottom of the tank. Moreover, the movement of the fish in tank 1 assists the processing of the sewage by aeration.

European carp are also well adapted for use with the invention as they can absorb oxygen from the air in the event that the oxygen content of the water is too low. However, it is proposed that the concentration of the carp should be high and the tank shallow so that the movement of the fish will cause agitation and oxygenation of the water.

With time, a layer of sediment 8 accumulates on base 2 comprised of the processed sewage and/or the fish themselves. Once sufficient material has accumulated in layer 8 the remaining water, designated by reference numeral 9 in FIG. 2, is pumped or gravity fed to an adjacent like holding tank 10. Alternatively, water 9 is allowed to slowly evaporate and the fish allowed to become incorporated into layer 8. Tanks 1 and 10 are interlinked by a valve 11 that is selectively opened to allow the flow referred to above.

Once the water is removed the layer 8 can be recovered from base 2 and processed into other products such as fishmeal and on sold as a stock feed supplement or the like. It will be appreciated that as layer 8 will be comprised of fish manure and/or the fish themselves that far fewer subsequent processing problems arise than would be the case with the original sewage that is provided into tank 1.

In some embodiments layer 8 is recovered prior to removal of water 9. Moreover, in other embodiments water 9 is further processed in tank 10 by additional fish. In either case, once the fish, or the layer that incorporating the fish, is removed, it is subsequently processed to produce fishmeal. This fishmeal is a mix of the fish themselves together with other coarse grains.

It will be appreciated that the concentration of fish within tank 1 is high and preferably in the order of 50 fish per cubic metre of sewage. It would be appreciated by those skilled in the art that in other embodiments alternative concentrations of fish are used.

In larger applications use is made of a plurality of holding tanks in parallel.

In other embodiments, the fish are periodically harvested. In the case of European carp, the harvesting is for the purposes of producing fishmeal from the carp.

That is, the embodiments of the invention allow for the processing of sewage to result in a high protein fishmeal that can be used to feed other fish or marine life—such as those farmed for human consumption.

In some embodiments the invention is used as a second stage treatment of sewage, with the prior first stage treatment removing about half of the solid matter within the sewage as well as reducing the concentration of ammonia and nitrates and other elements to level that will allow the habitation of fish within the sewage. Generally, sewage contains about 5% to 20% solids.

In a further embodiment of the invention, the water and sewage is progressively feed through a sequence of the tanks each of which contains high concentrations of European carp. The water that is released from the last of the tanks is, in this embodiment, suitable for release back into the environment as “grey water”. In some embodiments, however, the water requires further processing. This is dependent upon the nature of the sewage and the effectiveness of the fish in processing that sewage.

The term “grey water” is used within this specification in the normal sense. By way of further guidance, grey water is that water which is generally not deemed potable, but which is able to be released into the environment for human use. Example uses of grey water are for non-direct human consumption, such as irrigation, for the flushing of toilets, car washing, and certain industrial uses.

The progressive flow of the water and sewage through the tanks is maintained for a long period, presently envisaged as being in the order of two to four years. However, in other embodiments, the long period is up to about twenty years.

In this long period the fish are harvested and replaced, as required. At the end of the long period the fish are removed from the tanks and the remaining liquid being removed or allowed to dry so that the sediment remaining at the bottom of the tanks can be easily removed. This sediment is then used as a fertiliser or supplement for soil.

The progressive flow of water and sewage is then recommenced into the tank and additional fish released into the tank to recommence the process.

That is, the preferred embodiments of the invention offer two distinct alternatives to creating the fishmeal, these being:
1. Having a continuing flow of sewage through the tank and periodically harvesting the fish for processing into fishmeal; or
2. Having the flow of sewage segmented and allowing the fish to incorporate into the layer on the bottom of the tank, and subsequently retrieving and processing that layer to provide the fishmeal.

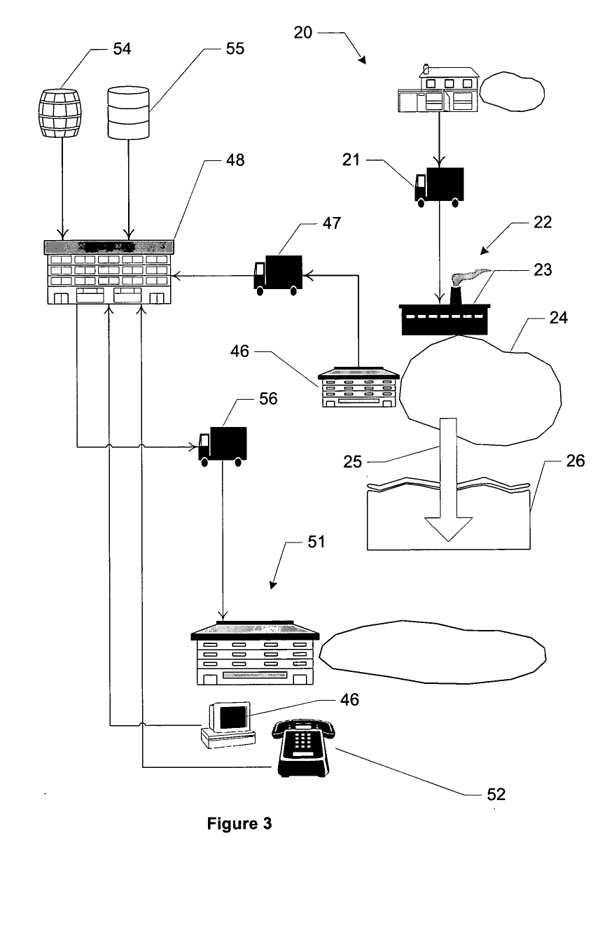

Reference is now made to FIG. 3 where there is illustrated schematically a further embodiment of the invention. More particularly, the process is commenced at a hatchery 20 where fish eggs (not shown) of the desired species are hatched. In this example, the fish are common European carp, although many other alternatives are available. Some other species that have been found well suited to this embodiment are oriental carp, as well as other fresh water species.

For the common European carp, the larva are allowed to grow, under controlled conditions, into fry which are about 60 mm to 70 mm long. More usually, the fry are control feed to ensure they have an average or mean weight that is within a desired range. At this stage, the fry are moved to a growth area (not shown) in hatchery 20 where they are subject to increased water temperatures and feed volumes to accelerate their growth into fingerlings that are about 100 mm to 120 mm long. In this embodiment, the average weight of the fingerlings is about 20 grams. It will be appreciated that there will be a statistical variation in length and weight of the fry and fingerlings at all stages and the abovementioned lengths and weights are not prescriptive of individual animals but rather indicative of averages across a large sample.

A typical time between the hatching of the eggs and the growth of the fingerlings to about 100 mm to 120 mm in length is about 3 months. The intention is to ensure that the fingerlings are old enough to be sufficiently robust to withstand the part they are to subsequently play in the processing of sewage, but at a point just prior to their major growth phase. Given this, it is possible that the above time frames will be, in other embodiments, considerably different, particularly if different animals are used or if other variables such as water temperature, feed rates, and hatchery densities are varied.

Once the European carp fingerlings are about 120 mm in length, they are transported, in this embodiment by truck 21, to a sewage treatment plant 22. In other embodiments, alternative means of transportation are used. Moreover, in some embodiments, hatchery 20 is adjacent to or part of plant 22 and, as such, minimal transportation is required.

Plant 22 is pre-existing and is for the treatment of human sewage. The plant includes an initial processing complex 23 that effects removal of large solid material from the sewage that is feed into plant 22. This large solid material is substantially organic and usually constitutes less than about four percent of the volume of the sewage. In this embodiment, where human waste is being processed, complex 23 passes 99.81% of the sewage received onto the next phase of treatment. In other embodiments, where alternative primary and secondary sewage treatments are used, complex 23 passes a different percentage of the sewage to the next phase of treatment.

Following this initial treatment, the sewage is then passed into a pond system 24, which will be described in more detail below. The pond system includes many interlinked ponds that are about 1 to 1.5 metres deep and which have a combined total surface area of about 350 hectares. The sewage flows sequentially through system 24 prior to exiting at an outlet 25. The dwell time of the sewage in system 24 is about six to ten days. However, in other embodiments, different dwell times are used. For example, in another specific embodiment the dwell time of the sewage in system 24 is between about sixteen to twenty six days.

By the time the sewage reaches the outlet it is so treated as to be able to be released into the general environment, at least as grey water. Examples of such treatment include a DAFF treatment, although other treatments are also used instead of or in addition to a DAFF treatment. In this embodiment, the sewage that progresses through outlet 25 is released into a body 26 of water. While in this embodiment body 26 is an ocean, in other embodiments it is a river or other waterway, or a grey water supply system (not shown).

In some embodiments the outlet feeds into further settling ponds where the treated sewage resides prior to being released into body 26.

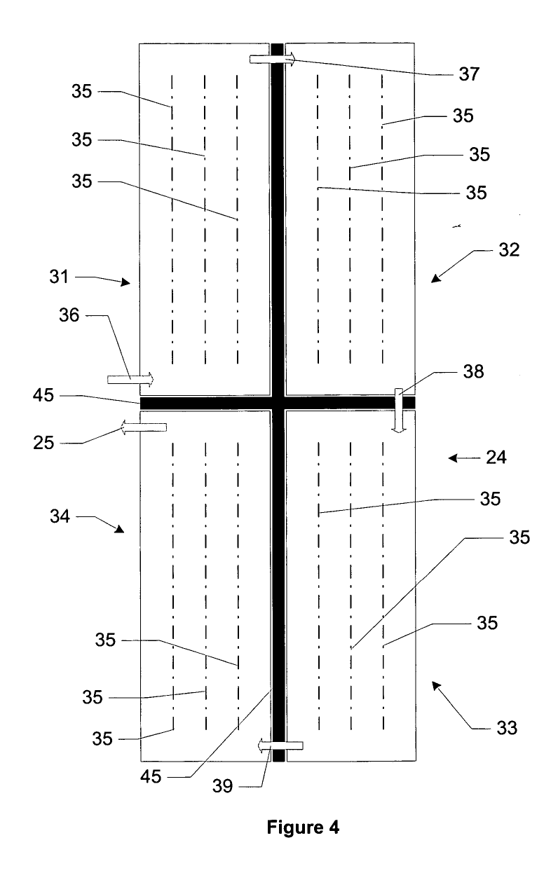

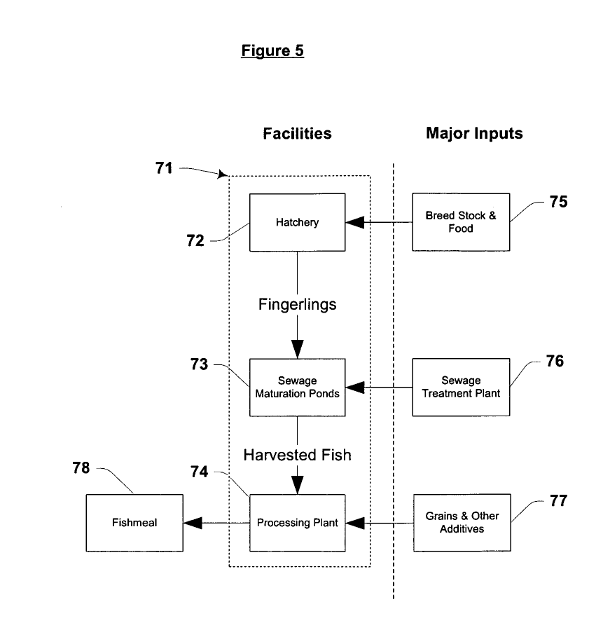

As best shown in FIG. 4, system 24 includes four interconnected ponds 31, 32, 33 and 34. Additional ponds are included in other embodiments. Each pond is about 1.2 metres deep and segmented by three parallel 1.5 metre high walls 35. These walls are made of a plurality of adjacent solid plastics panels that are each about 4 metres in length. The panels are retained in the ponds by an array of poles (not shown), where each panel extends between two adjacent poles. In other embodiments alternative retaining means are used.

In further embodiments, no poles are used and the panels are made from reinforced concrete. That is, the weight of the panels is sufficient to ensure the respective positioning of the panels within the pond is substantially maintained without the need for additional securing to poles or other supports. In these further embodiments, the concrete panels are interconnected with each other and rest upon the bottom of ponds 31, 32, 33 and 34. This particular arrangement has the advantage of minimally disturbing the bottom of the ponds to sink holes in which to mount the base of the poles or other means for support.

Walls 35 define channels within each of the ponds through which the sewage flows. Additionally, the walls provide a site for attachment of a plurality of nylon nets (not shown) that further segment the channels into a number of compartments for containing live fish. That is, the nets are connected to two adjacent posts and extend down the wall, across the bottom of the channel, and up the other wall. Use is made of nylon nets due to their durability and rot resistance. In other embodiments, alternative nets are used. Examples of such other nets are those made from polycarbonate or other plastics, hemp, or plastic coated materials such as plastic coated wire.

Sewage is delivered into pond 31 through a conduit 36. In some embodiments, this conduit includes a regulator for metering the flow of the sewage into the pond.

Once in pond 31, the sewage progresses through the channels before passing through a conduit 37 and into pond 32. A similar progression occurs with pond 32, 33 and 34 and associated conduits 38 and 39. After the sewage moves through the channels of pond 34 it leaves via outlet 25.

The ponds are separated by intermediate access roads 45.

Each of the nets within the channels defines a maturation pond for the live fish that are delivered to plant 22. That is, upon delivery, a predetermined quantity of fingerlings are released into one or more of the compartments. The apertures in the nets are such as to minimise the risk of the fingerlings being able to move between adjacent compartments.

For the European carp of the present embodiment, the quantity of fingerlings that are released into each compartment is about 0.5 kg/m³. While there is considerable variation between compartments, typical depth, length and width dimensions for a compartment in this embodiment are 1.2 m×4 m×5 m. That is, such as compartment has a volume of about 24 m³ and, as such, about 12 kg of live animals are released into the compartment. At the time of release, the animals are about 120 to 160 grams, which results in the compartment containing about 75 to 100 animals.

With all the compartments so stocked with animals, the sewage is processed by those animals consuming the solids and as well as the nutrients that are contained within the sewage.

European carp are bottom feeders and are preferred as not only do they consume and otherwise process the solids and nutrients contained within the sewage itself, but they also stir the sediment contained on the bottom of the compartments to such an extent that it is retained in the flow of sewage through the pond system. This agitation and aeration of the sewage also assists other subsidiary processing. Particularly, the processing of the sewage is facilitated by sunlight that impinges upon the surface of the ponds. The agitation of the flow by the animals allows more of the water to be circulated through the upper levels of the ponds and thereby increases the uniformity of the treatment provided by the sunlight.

Alternative embodiments make use of compartments that have nets that keep the fish away from the bottom of the ponds. This need arises in some pond systems where the pond bottom is too easily disturbed and, if the fish did have access to it, the sewage would be so muddied as to prevent sufficient sunlight from entering the sewage. The penetration of sunlight has the added advantage of encouraging algae growth, which is also consumed by the fish.

In some embodiments use is made of alternative species of animals. In further embodiments, use is made of a combination of species. For example, in addition to the bottom feeding carp referred to above, some embodiments use mid line feeders such as Mora rainbow fish or bream. That is, a poly-culture is established within the pond or ponds. Another example includes the use of top line feeders such as oriental carp or trench. It will be appreciated that the top line feeders need not be so robust, as the conditions in the upper level of the sewage will be far less severe than at the lower levels due to the action of the sunlight referred to above. In the case of the animal, the sunlight is advantageous as it also helps in killing pathogens in the sewage. Accordingly, many more species of animal are applicable in the upper levels.

In some embodiments, each compartment includes bottom feeders, mid line feeders and top feeders.

After about three months following the release of the European carp into the compartments in a temperate environment, those carp will have grown to an average size in the order of about 200 mm to 250 mm. In colder environments and with lower concentrations of sewage the growth rates will be less. Conversely, in warmer environments the growth rate is typically greater. Additionally, and as would be appreciated by those skilled in the art, other species of animal will have different growth rates. Ultimately, the growth rates are driven by the age of the animals, the nutrient available to those animals, the temperature, and the number of animals in a given volume. Accordingly, in warmer climates, it is possible to have high growth rates in embodiments only having low nutrient levels in the sewage.

At this time, the animals are harvested, in that they are removed from the compartments. In practice, this achieved by drawing together the top edges of the relevant net, and lifting it out of the pond, together with the entrapped animals. This net is then loaded onto a transport vehicle and taken to a warehouse 46 that is located adjacent to pond system 24. Access roads 45 facilitate this transport step.

Once the net has been removed from the relevant pond, a new net is secured to walls 35 and/or other securement points to redefine the respective compartment. A fresh batch of fingerlings from hatchery 20 is then released into the redefined compartment. This process of removal of the more mature animals and the subsequent release of the fingerlings is respectively referred to as harvesting and sowing.

In other embodiments, the net is drawn together and removed from the compartment and immediately emptied into a truck mounted bin or container. Thereafter, the net is again secured to define the compartment and restocked with new fingerlings, as described above.

The rationale for harvesting the animals from the compartments after three months is because their growth rate is beginning to slow considerably. Accordingly, it is more beneficial—from both a sewage processing and an animal tonnage point of view—to have younger animals replace the more mature animals.

In this embodiment the harvesting and sowing occurs on a rotation basis so that a continuous and sequential process is instituted for system 24. However, in some embodiments, the growth rate of the animals is not uniform across all compartments and selective harvesting is used. For example, where different compartments contain different animals, different combinations of animals or different concentrations of animals. Non-uniform growth rates also occur where there is an unequal distribution of nutrients to the compartments due to the fluid flows through the ponds. So, for the compartments in pond 34, the animals generally experience a slower growth rate than the animals in pond 31. Another factor that affects growth rates between compartments is the flows of the sewage through the ponds. In some cases there are hydrodynamic “dead zones” where the sewage is relatively stagnate and, as such, there are less solids and nutrients made available to the animals. In some embodiments use is made of baffles and other flow adjustment devices that are placed in the ponds to ensure that all compartments receive the flow of sewage that is required to affect the desire uniformity of growth between the compartments.

Once taken to warehouse 46, the carcasses of the harvested animals are centrally inspected. This inspection includes weighing, sampling for pathology testing, sorting, tagging and other data collection. Other quality control operations are also performed at this point.

Those carcasses to be further processed are transported, in this case by a truck 47, to a fishmeal processing plant 48. Preferably, this transportation occurs as soon as practically possible after the harvesting and inspection of the animals.

The carcasses are loaded onto a wire mesh conveyor (not shown) and passed through a heating system to kill any remaining pathogens in the animals. In other embodiments, use is made of alternative conveyors such as a screw conveyor or the like.

The heating also has the effect of drying the animals. The removal of fluids in this controlled way also allows the removal of heavy metals and other undesirable materials and diseases that, if present, are contained predominantly within the fluids of the animals.

It is typical for the heating and drying to result in a 60% to 70% weight reduction from the carcasses provided. (That is, only about 30% to 40% of the weight of the initial carcasses remains for further processing). In other embodiments the heating and/or drying results in greater weight reductions than the 60% to 70% reduction referred to above.

It is preferred that use is made of a “dry” process to better ensures the elimination of pathogens.

After the heating process it is usual to conduct an additional inspection of the animals. This includes a visual inspection as well as pathology testing for pathogens, viruses or other undesired life forms. In some embodiments the inspections are continuous, and the testing frequent, while in other embodiments the inspections are periodic and the testing random. The regularity of the inspection and testing is in part determined by the end use of the resultant fishmeal, and the history of contaminants for the animals.

The dried carcasses, in their entirety, are then cut, ground or shredded into thin pieces of about 1 cm². In other embodiments, the shredding is to a different size.

The fish pieces include all the bone, gut, skin and flesh of the carcasses. In other embodiments, however, one or more of these constituents are removed, although prior to the drying process.

In other embodiments, the heating and/or drying also includes cooking of the carcasses. Moreover, in some embodiments the step of heating/cooking and the step of shredding occur in the same processor. In some embodiments, the steps are performed simultaneously, while in other embodiments the steps occur sequentially.

The pieces are combined with measured proportions of additives to form a fishmeal mix that is stockpiled in plant 48 until the moisture content of the mix is about 12% by weight. Usually this will take about two or three days although, in some cases, two to three weeks is required. To assist the drying it is possible to periodically turn the stockpile. A less preferred alternative is to include within the mix an additive comprised of dry powder. The longer time the mix is in the stockpile also allows a greater breakdown of the fish pieces.

In the preferred embodiments, however, there is no stockpiling of the fishmeal but, rather, the step of applying further heat to the fishmeal to quickly have that fishmeal arrive at the target moisture content.

In other embodiments the target moisture content of the mix is in the range of 10 to 15%. The selection of the target will be dependent upon the desired storage life of the product, as a less moist mix will keep longer.

The additives that are included within the mix are dependent upon the intended use of the resultant fishmeal. Examples of such additives include grains such as crushed cereal grains, or powders such as powdered vitamins and powdered proteins (due to the loss of protein that occurs during the drying process). Other additives that are selectively used in embodiments of the invention include dietary fibre or other roughage. In this embodiment, the resultant meal is intended for feeding to other animals and, in particular, to a specific species of fish. Accordingly, the additives are commonly, wheat, barley & other heavy seed supplements, together with specific vitamin and minerals for the fish species. In other embodiment, such as for pig feed, the additives are typically of similar categorisation, although in different proportion. It will be appreciated, from the teaching herein, that many other additives and combinations of additives are available.

The stockpiled mix, once having the required moisture content, is extruded at high pressure through a die having a diameter of about 5 mm. Because of the low moisture content the extruded material forms into fishmeal pellets of varying size. If required, the pellets are graded for size. In other embodiments the pellets are passed through a set of rollers to provide greater uniformity of pellet size.

In other embodiments different diameter dies are used.

The pellets are packaged in bags, boxes or other containers and stored temporarily for transportation to customers.

As mentioned above, in this embodiment, the fishmeal pellets are intended as feed for fish. By way of example, a customer having an aquacultural enterprise 51 places an order for the desired pellets by way of telephone 52 or computer 53 which is connected to the internet or other network. Where computer 53 is used, provision is made for the customer to specify and particular requirements or characteristics that the resultant pellets must have. This could include the inclusion of certain vitamins or protein content or otherwise.

In response to the order, the operator of plant 48 determines if the existing stocks of additives 54 and 55 are sufficient and, if so, commences production of the required pellets. Once so produced, the pellets are packaged and transported by truck 56 to enterprise 51.

Prior art fishmeal has traditionally only included the discards of the fish, such as the scales and guts. As the fishmeal pellets of the present invention are formed from the whole carcass of the fish they are comparatively high in protein content.

In some embodiments, the harvested fish are for human consumption. Generally, such fish are top feeders and undergo additional testing following the harvesting to provide greater assurance to the intended consumers of their fitness for purpose.

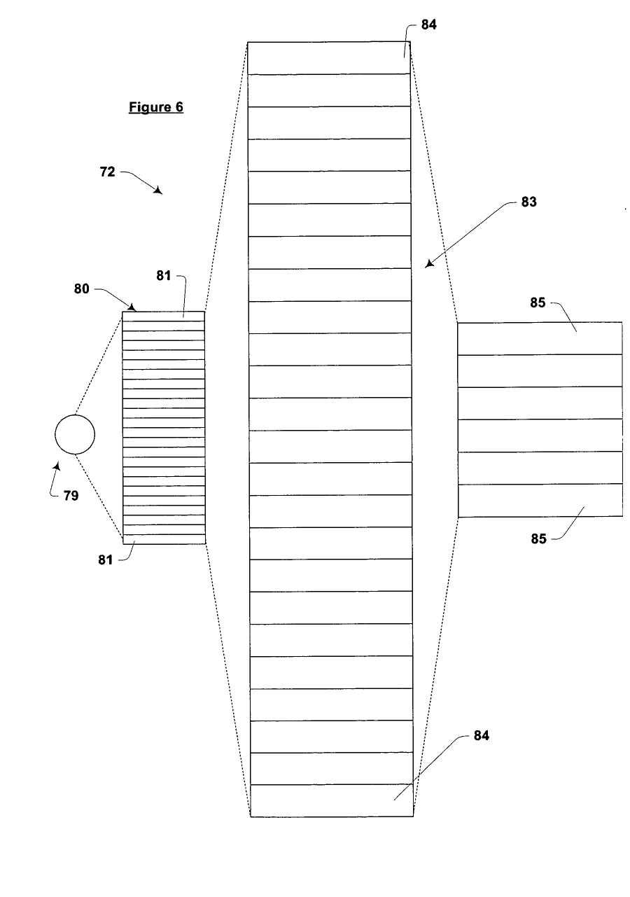

Reference is now made to FIG. 5 where there is illustrated schematically a further preferred embodiment of the invention in the form of a system 71 for producing fishmeal from sewage. Some elements of this embodiment are shared with one or more of the earlier embodiments and will not be described further.

System 71 includes three main facilities, these being a hatchery 72, a system of treated sewage maturation ponds 73 and a fish processing plant 74. In this embodiment, each of hatchery 72, ponds 73 and plant 74 occupy respective sites, all of which are disposed adjacent or near to each of the others. This facilitates transportation of materials between the separate facilities. However, in other embodiments, one or two of the three facilities are not near or adjacent to the others. For example, in some embodiments the site of one of the facilities is predetermined due to existing real estate and capital equipment. Typically, this is due to the pre-existence and/or location of a sewage treatment plant where urbanisation or other factors prevent the near placement of the other facilities.

In alternative embodiments, one or more of the facilities are provided by more than one of that type of facility. For example, a single system of ponds 73 is, in one embodiment, provided with fingerlings from a plurality of spaced apart hatcheries. It will be appreciated therefore, that reference to one of the facilities in the singular is, in the absence of clear context to the contrary, intended to encompass both the singular and the plural form of that facility.

In broad terms, hatchery 72 is the recipient of brood stock and food from a source 75 for producing fingerlings that are to be transported to plant 73. The production of these fingerlings is undertaken in a structured and reproducible manner such that the time between the initial hatching of a batch of eggs, to the transportation of the fingerlings from hatchery 72 is a predetermined period. In this embodiment, where the brood stock is the Common European carp (Cyprinus Carpio), the predetermined period is about seventy seven days. In other embodiments different predetermined periods are utilised depending upon the level of maturity required from the fingerlings to be transported, the growth rates that are able to be achieved, and other factors that, based upon the teaching herein, will be clear to those skilled in the art.

It has been found that more typically—for applications where the fingerlings are to be subsequently disposed in water that is open to birds that prey upon fish—the predetermined period is about 70 days to 90 days. For hatchlings younger than the lower limit, there is a great risk that they will be consumed by such birds, or indeed, other larger fingerlings or fish. Clearly, if use is made of growth accelerating methodologies—such as heavy feed schedules and raised water temperatures—it is possible to reduce the abovementioned lower limit. However, that more than usually involves additional expense being incurred.

While there is a need to maintain the fingerlings within hatchery 72 to mature, the competing factors are that the longer that time, the greater the unit cost for producing the fingerlings. Moreover, if the fingerlings are too mature, it will degrade of the benefit provided by those fingerlings in ponds 73, as they will spend more of their high weight-gain growth phase consuming feed in hatchery 72, and less consuming the treated sewage in ponds 73.

As presently envisaged, for the species of animals being bred, the balance of growing the fingerlings to about 20 grams in the period of about seventy five to eighty days has proved successful. For periods longer than this there is a need to more tightly control the feed metered to the animals, whereas for lesser periods there is a need to resort to growth accelerating methodologies such as raising the water temperature, overfeeding, and including nutrient additives in the food and/or water.

The fingerlings are transported live to ponds 73 where they are placed in one or more tanks, ponds, containers or the like, through which a flow is established of secondary treated sewage that is obtained from a source in the form of a sewage treatment plant 76. The fingerlings are selected to not only survive within the ponds, but also to consume and otherwise process the treated sewage and the organic matter growing or living within the sewage. The result of which is that the fingerlings grow and mature into juvenile fish. The fish are then harvested from the tank or tanks after about one predetermined period from the fingerlings being placed into the tank or tanks. The harvesting occurs when the fish are about 154 days old and, hence, prior to the fish maturing into adulthood. Accordingly, the fish are removed prior to their growth rate—measured in terms of weight gain—slowing dramatically. In other embodiments, however, where the weight of the harvest is secondary to the processing of the sewage, the fish are harvested from the tank or tanks after an integral multiple of the predetermined period has elapsed since the placement of the fingerlings within that tank or tank.

Use is made in this specification of the term “biomass” to indicate that total weight of animals supported by a surface hectare of a pond. A surface hectare is that volume of fluid within a pond measuring one hectare (100 metres×100 metres) and having a depth of 1 metre. It will also be appreciated that the biomass is measured at the time of harvest of the animals. Accordingly, a biomass is that weight of harvested animals that were supported by 10,000 m³ of pond volume.

The embodiments of the invention achieve a biomass of about 5 tonnes to 20 tonnes. The specific embodiment being described with reference to FIGS. 5 to 10 achieves a biomass of between about 8 to 16 tonnes, depending upon the time of year—due to water temperature variations—and the nutrient value of the sewage, amongst other things. Where it is possible to more tightly control the treatment of the sewage that is placed into the ponds, it has been found that continuous achievement of a biomass of at least 10 tonnes is possible and, in warmer climates, of at least 15 tonnes.

The fish, having been harvested, are transported to plant 74, and processed, together with grains and other additives from a source 77. This processing leads to the production of fishmeal 78. The time between the fish being harvested and the fishmeal being produced that is derived from those fish is, in this embodiment, about one predetermined period.

It has been appreciated by the inventors that the large scale implementation of the invention is a capital intensive and complex interaction between three quite separate facilities. The commencement and end of the cycle of the processing at each of the facilities in system 71 are synchronised to optimise the rate of production for a given capital investment.

It will be appreciated that some variation of the cycle between facilities is tolerated by system 71. More particularly, the predetermined period is in the present embodiment set to allow a two-day window of error. That is, where the predetermined period is seventy seven days, the growth rates of the fingerlings is planned such that they are able to be transported to plant 73 within seventy five days to seventy nine days, should the need arise. Where the fingerlings kept for an additional two days within hatchery 72, they will be on a reduced food allowance and/or in cooler water for that additional time.

Reference is now made to FIG. 6 where there is illustrated schematically hatchery 72. Particularly, hatchery 72 includes a brood area 79 where the fish brood stock is maintained. While, in this embodiment, area 79 is schematically represented as a single zone, in other embodiments it is spaced apart over a plurality of separate zones. In alternative embodiments, the brood stock is kept offsite, and transported to hatchery 72 as required.

By way of background, the growth of a fish includes a number of distinct stages including sequentially: an egg; a larva; a fry; a fingerling; a juvenile animal; and an adult animal. For the species of animal used in the present embodiments, and on the feeding regimes that are used, a typical chronological progression following hatching for an animal includes:
Day 0 to about day ten: a larva.
Day 10 to about day 30: a fry.
Day 30 to about day 130: a fingerling.
Day 130 to day 154 (the usual upper limit for the animals in the preferred embodiments): commencing the transition to a juvenile animal.

The above figures are indicative only and it will be appreciated by those skilled in the art that considerable variation occurs within a given batch of animals. Moreover, it is also appreciated that more of less favourable environmental and feed conditions will considerably alter the progression of the fish through the abovementioned sequence.

Area 79 is also the site for the collection and fertilisation of the eggs, and where the eggs are stored until hatched.

Also included within hatchery 72, and disposed adjacent to area 79 is a hatching tank 80 that is defined by an array of 24 parallel and adjacent like raceways 81. It will be appreciated that, for clarity purposes, only the two raceways at the respective ends of the array have been specifically numbered and, that in other embodiments, alternative numbers of raceways are used. The raceways are built on a common concrete base, and include continuous concrete walls that extend upwardly from the base. Each raceway 80 has a length of about 8 metres, a width of about 1.5 metres, and a depth of about 1.15 metres. The average depth of the water contained within each raceway is about 0.95 metres, which equate to each raceway containing about 11.3 m³ of water.

In other embodiments different raceway dimensions are used.

Raceways 81 divide tank 80 into a corresponding number of ponds for separately containing the hatched larva. It will be appreciated that the larva are disposed within the respective raceways immediately after, or very soon after, their hatching from the eggs.

Hatchery 72 also includes a nursery tank 83 that is disposed adjacent to and generally parallel with hatching tank 80. Tank 83 is defined by an array of 24 parallel and adjacent like raceways 84. It will be appreciated that for clarity purposes only the two raceways at the respective ends of the array have been specifically numbered. The raceways are built on the common concrete base, and include continuous concrete walls that extend upwardly from the base. Each raceway 84 has a length of about 11 metres, a width of about 2.4 metres, and a depth of about 1.5 metres. In other embodiments different raceway dimensions and numbers of raceways are used. Raceways 84 divide tank 83 into a corresponding number of ponds for separately containing the fry/fingerlings that are disposed within the respective raceways.

An array of six adjacent but separate grading tanks 85 are disposed adjacent to tank 83 for receiving the animals once they have been released from tank 83. It will be appreciated that for clarity purposes only the two tanks at the respective ends of the array have been specifically numbered. Tanks 85 include gates (not shown) through which the animals are received, and fish counting equipment disposed adjacent to the gates. The gates include actuators and sensors for allowing remote operation of the gates and counters. This allows data to be gathered that this indicative of the collective biomass contained with any one of tanks 85. In other embodiments, a different number and/or configuration of tanks 85 are used. It will be appreciated that the gates and counting equipment used in this embodiment are all centrally monitored and controlled by a common central controller in the form of a computer network (not shown) having a plurality of interconnected computers and associated hardware.

Also included within hatchery 72 is a plurality of interconnected and gated channels (not shown) that allow selectively interconnection of any two raceways or any one or more raceways and any one or more of tanks 85. This allows the selective transfer of animals between the raceways and tanks 85. In this embodiment, the channels include a plurality of gates that are actuated either manually or via the central controller. Where manual actuation is relied upon, the gates include sensors for providing the central controller with signal that are indicative of the open or closed state of the gate.

Hatchery 72 includes a food dispensing system (not shown) for dispensing predetermined quantities of one or more desired foods into respective raceways 81 and 84 at predetermined times. The dispensing system is automated and configurable to accommodate for each raceway:
The commencement of a feeding schedule.
The completion of a feeding schedule.
The scheduled feed time or times in the schedule
The quantity and type of feed provided at the or each feed time.

The dispensing system takes the form of two separate motorised carriages that are mounted above respective tanks 81 and 83 and which are able to traverse along those tanks to be selectively disposed immediately above all the raceways of that tank. The traversing of the carriages is controlled via the common central controller, which is responsive to sensors disposed along the tanks for issuing control signals to a variety of actuators and motors mounted on our about the carriages.

The carriages each support one or more feed containers from which feed is metered into the desired raceway in response to the control signals from the controller.

In operation, the brood stock in area 79 is used to provide batches of fertilised eggs. In this embodiment, the brood stock includes both male and female animals that are located in separate tanks (not shown). Leading up to the requirement for a batch of fertilised eggs, the water temperature of the tanks containing the brood stock is raised, and hormones or other catalysts injected or feed to the stock. The female animals are then manually milked, and the eggs stored in sweet water. In this embodiment, the sweet water is held in a number of generally cylindrical transparent containers. The transparent nature of the containers facilitates visual inspection of the contents of the containers.

The male fish are then manually manipulated to extract semen, which is also placed into the containers, and pre-mixed into the existing contents of the containers. While it will be appreciated by the skilled addressee that a variety of pre-mixing methodologies are available, in this embodiment it is performed either manually with a feather or the like, or mechanically, and slowly, with a soft mixing wand.

The mixture is subsequently placed in a separating device that, through slow rotation, at least partially separates the coated eggs from the remainder of the mix. This slow rotation is continued for about two to four days until substantially all the eggs are hatched. During this time, the containers and their contents are monitored regularly to ensure that, once the hatching occurs, the larva are quickly taken from the container. It is usual for most of the eggs within a single batch to hatch in quick succession. Even so, there will inevitably be, for each batch, some eggs that remain un-hatched, and which are discarded.

The hatched larva then placed into one or more of raceways 81, and this designates the start of the predetermined period.

The raceways contain water that is maintained at a predetermined temperature to facilitate survival and growth of the larva into fry.

It will be appreciated that the larva emerge from the eggs with an egg sack that contains sufficient nutrition to keep the larva alive for about two days after that after they are placed within raceway 81. Accordingly, the central controller is configured to commence feeding to the one or more raceways 81 after about one to one and a half days have elapsed since placement of the larva into that or those raceways. Due to the size of the animals at this time, the size of the feed particles is quite small and takes the form of a “crumble”. Both the quantity and type of the feed is controlled in this embodiment.

Due to the spread of time over which the hatching occurs, and the large standard deviation in growth rates of the larva, there is a need to periodically grade the animals by size. Otherwise there would be significant losses of animals due to the larger ones consuming the smaller ones.

Prior to the first grading, there is an initial removal from the one or more raceways 81 of the underdeveloped or poorly developed animals. This cull is intended to remove the animals that are subject to an increased risk of premature death. For example, those animals with poorly developed swim bladders are removed by skimming the raceways.

The grading starts after about 21 to 28 days from placing the larva in the raceway, and is performed again about once every seven to ten days. That is, the larva are only graded in raceway 81 once. The other grading occurs once the animals have been transferred to the larger raceways.

The exact timing of the grading is determined by the type of fish being used, and through regular observation and assessment of the relative sizes of the animals in a given raceway. For example, the animals sporadically undergo “growth spurts” where some of animals will increase quickly in weight. The others of the animals, if in isolation, would undergo a similar growth spurt at a later time. However, that difference in timing, particularly when the animals are young, results in time when animals of considerably different weights are cohabiting a single raceway.

Presently, the grading is undertaken by progressing a net along the relevant raceway, where the net has a predetermined aperture size. The netted animals, being the larger, are moved to a separate raceway and away from the smaller animals. In this way only like sized animals are contained within a given raceway 81.

The feed dispensing system is updated with information indicative of the age, number and average weight of the animals contained within a given raceway to ensure that the dispensing of food occurs that best suits the rates of growth being targeted.

After about 28 to 35 days from the initial placement of the larva in one or more of raceways 81, the resulting fry are transferred to one or more of the raceways 84 in tank 83. As mentioned above, the animals are closely observed for variations in growth rates, and graded ever seven to ten days to group like sized animals together.

The animals remain in tank 83 for about forty two to forty nine days, which equates to about seventy seven days following the placement of the corresponding larva in tank 80. During the time in tank 83 the controlled feeding is continued to result in the fry growing to fingerlings with an average weight of about 20 grams. In alternative embodiments alternative average weights are provided for.

In other embodiments the period between placement of the larva in tank 80 and the fingerlings being available for transportation to ponds 73 is other than seventy seven days. In all the preferred embodiments, that period matches the process cycle for one, or both, of ponds 73 and plant 74.

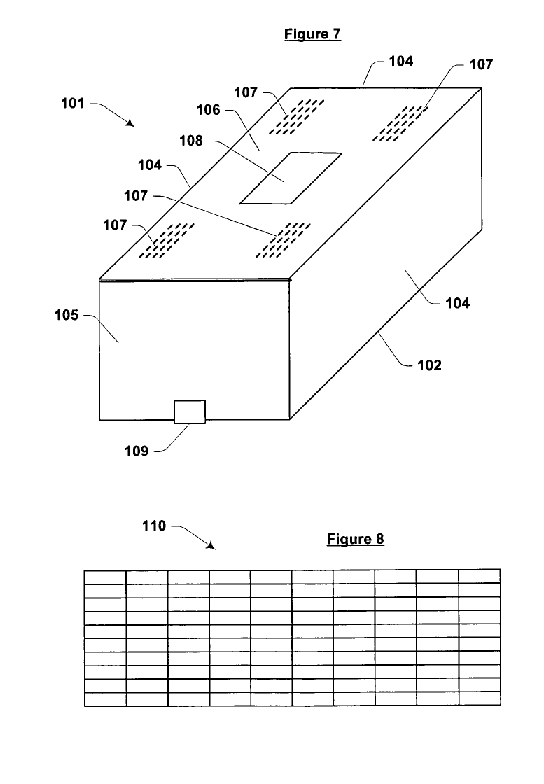

At or about one predetermined period since the placement of the larva in tank 80, the corresponding fingerlings are moved into one or more of tanks 85. Each animal enters one of the six tanks via a respective gate (not shown) that includes a fish counter (not shown). As such, the central controller gathers data indicative of the number of animals that progressively accumulates within the or each tank. In this embodiment, the animals are accumulated and transferred to a plurality of transportation containers 101 that is schematically illustrated in FIG. 7. The requirement of ponds 73, as will be discussed further below, is batches of about 2 million animals. These animals are maintained together for inclusion within a common zone—which is described further below, and which is referred to as a subdivision—within ponds 73. Due to the common operation of hatchery 72 and ponds 73 there is a high degree of coordination of the animal numbers within batches. However, in other embodiments, where the operation is separate, the animals are batched otherwise. For example, in one embodiment, the animals are batched in unit total weights in a given container, while in other embodiments, the animals are batched in animals numbers in a given container to allow the operator of ponds 73 to order from the operator of hatchery 72 the desire number of containers of those animals.

Transportation container 101 is substantially watertight and has a volume of about 4 m³. Container 101 includes a generally rectangular base 102, three integral sidewalls 104 that extend upwardly from the base, and a gate 105 that is hinged for movement between an open and a closed configuration. Container 101 also includes a generally rectangular top 106 from which gate 105 is hinged, where the top has a plurality of arrays of spaced apart apertures 107 for allowing air to pass to and from the container. These apertures are small—typically about 2 mm in diameter—and include, in some embodiments, a mesh covering to minimise the passage of water through the apertures during the transportation. Top 106 also includes a generally rectangular centrally disposed transparent observation window 108 through which the animals are able to be observed by the relevant personnel.

Gate 105 is shown in the closed configuration in which it is sealingly engaged with the adjacent walls 104, base 102 and top 106. The gate is maintained in this configuration by a lock 109 that latches between the bottom edge of gate 105 and the adjacent edge of base 102.

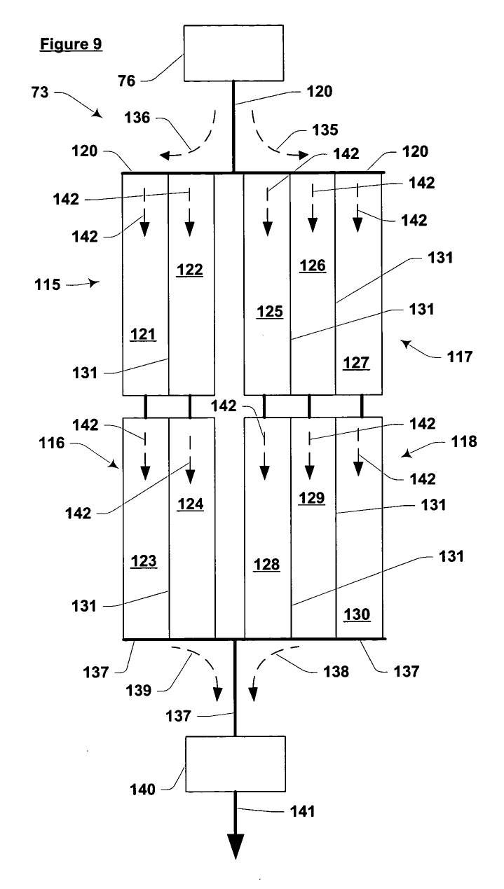

Nested within container 101 is a steel cage 110, the latter being schematically illustrated in FIG. 8. Cage 110 fits snugly within the container and is configured for retention within and removal from the container when gate 105 is in the closed and open configuration respectively. It will be appreciated that cage 110 is constructed from a wire mesh that has an aperture size of about 3 mm×3 mm to prevent substantially any movement of the fingerlings through that mesh. Cage 110 also includes hinged gate (not shown) that, in use, is adjacent to gate 105.

It will be appreciated that FIG. 8 is schematic and, while being representative, is not to scale.

In use, cage 110 is removed from container 101 and submerged in a channel in hatchery 72 on the opposite side to the gate that defines the extent of one of tanks 85. The fingerlings in that tank are allowed to progress through that gate and are counted as that occurs. Once a desired number of fingerlings have moved through the gate, that gate is closed in response to a signal from the central controller. One of the personnel in hatchery 72 then closes the gate of cage 110 to entrap the fingerlings within cage 110.

With cage 110 still submerged in the channel, container 101 is also submerged in the same channel, and then the two relatively progressed toward the other to nest the cage, together with the fingerlings, within the container. Gate 105 is then closed and lock 109 latched and the container is ready for transportation.

It will be appreciated that in other embodiments that use is made of alternative containers or transportation methods. Moreover, in other embodiments, different quantities of animals are placed within different containers. For example, in other embodiment, use is made of stainless steel fish carriers having dimensions of about 2 m×2 m×1 m and which are stacked or other collectively mounted on a truck or other vehicle for transportation between sites. Also included is one or more oxygen pumps for aerating the water in the carriers to optimise survival rates of the animals being transported. These carriers include a large diameter inlet hose through which the animals progress into and from the carriers. Preferably, the hose is at least translucent, or includes an at least translucent window, for allowing the animals to be counted as they progress into and/or from the carrier.

The, or each, of the containers 101 are loaded onto a transportation vehicle and transported to ponds 73 where they are subsequently placed within pools, ponds, tanks, or sub-divisions thereof, through which secondary treated sewage flows.

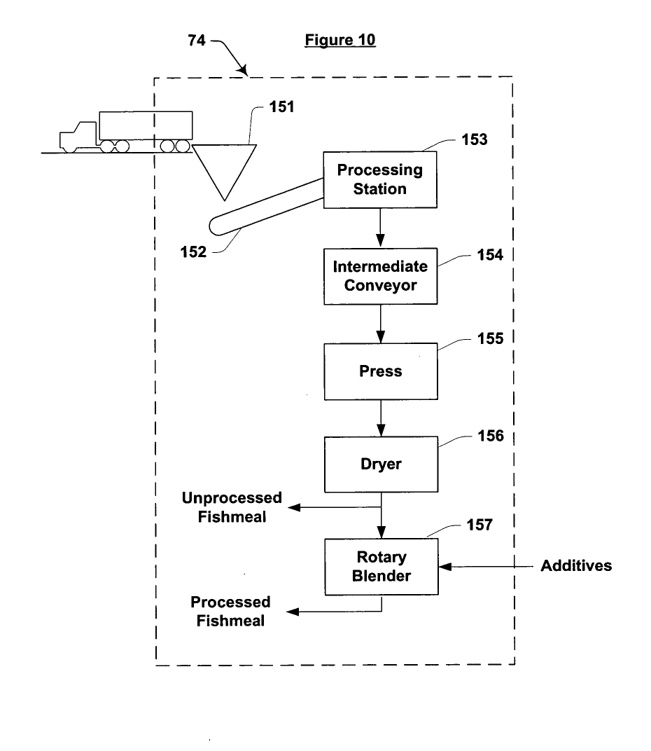

In this particular embodiment, and as best shown in FIG. 9, ponds 73 receive secondary treated sewage from sewage treatment plant 76. This plant 76 includes the major processing steps of:
Grit removal.
Pre-aeration.
Primary settling.
Biological filtering
Aerating.
Secondary settling.
Digesting.
Mechanical dewatering.
Sludge drying.

It will be appreciated by the skilled addressee that these steps are performed in sequence and in parallel depending upon the nature of the sewage treatment.

Plant 76, in addition to the above, also includes processes for reducing the nitrogen concentration of nitrate and ammonia in the sewage to make conditions within the sewage more favourable for animal survival. While the species of the animal is able to be selected to best survive within slightly higher concentrations of these compounds, there is still a bias to lower levels to improve growth rates and survival rates for those animals. It has been found in practice that the nitrate and ammonia levels in the sewage should be maintained at less than about 10 units/litre, and more preferably below about 8 units/litre. By way of comparison, raw undiluted sewage typically has a nitrate and ammonia levels of greater than about 28 units/litre.

A surprising result of reducing the nitrate and ammonia levels has also been found. Not only does such a reduction improve the growth rates and the survival rates for the animals that are placed in the treated sewage, it also better encourages the growth within the treated sewage of phytoplankton and zooplankton. As will be described below, this provides an additional source of nutrition for the animals, further enhancing their survival and growth rates of the animals in ponds 73.

Ponds 73 are disposed adjacent to plant 76, and in this embodiment, take the form of four generally rectangular ponds 115, 116, 117 and 118. The total area of ponds 115 to 118 is about 350 Hectares, and the average depth is about 1.5 metres. In other embodiments, other numbers and/or sizes of such ponds are used. The ponds are linked to plant 76 by system of channels 120, and it is through channels 120 that the secondary treated sewage is progressed into the ponds.

Each of ponds 115, 116, 117 and 118 are subdivided into a plurality of separate subdivisions by concrete walls formed from interlinked concrete blocks (not shown). The blocks rest upon the bottom of respective ponds and are interlinked with adjacent blocks to prevent the passage of the animals between the subdivisions. In some embodiments, the or part of the blocks are also covered by a fabric, plastic, net or other barrier to further reduce the risk of animals progressing between different zones. It will also be appreciated by the skilled addressee that the tops of the blocks extend above the normal water level in the respective ponds. Moreover, the tops of the blocks are substantially planar and about 300 mm wide. In use, a walkway or pathway (not shown) is mounted to and extends along the entirety of the adjacent interconnected blocks to allow personnel to walk along the concrete walls between the subdivisions.

In this embodiment, pond 115 is divided into two substantially equal volume subdivisions 121 and 122, while pond 116 is divided into two substantially equal volume subdivisions 123 and 124. Pond 117 is divided into three substantially equal volume subdivisions 125 and 126 and 127, while pond 118 into three substantially equal volume subdivisions 128 and 129 and 130. The sub-dividers between respective sub-divisions—which, as discussed above, in this embodiment take the form of interconnected concrete blocks—are designated in FIG. 9 by reference numeral 131.

The subdivisions are all of substantially equal volume and, in use, separately accommodate animals of different maturities. Each subdivision is about 52.5 surface hectares.

The separation of the subdivisions allows for progressive and sequential placement of the animals into those subdivisions, and the subsequent progressive and sequential harvesting of the animals from those subdivisions. The sequence of placement and harvesting typically corresponds given that any one animal is intended to remain in the respective subdivision for one predetermined period.

In other embodiments, the sub-divisions, while not all having equal volumes, have respective volumes that are approximately an integral multiple of a predetermined unit volume. In further embodiments, the volume of respective subdivisions is other than an integral multiple of the predetermined volume.

The predetermined unit volume is used by the operator of ponds 73 for allowing ease of calculation of the number or weight of animals that is to be initially placed within a given pond. This facilitates interaction with the operator of hatchery 72. While in this embodiment the operators of hatchery 72 and ponds 73 are common, in other embodiments those operators are separate parties engaged contractually for the supply of the animals for an agreed consideration. The unit volume calculation also has the benefit of facilitating interactions with the operator of plant 74. Again, in this embodiment the operator of plant 74 is common with the operator of hatchery 72 and ponds 73, however, in other embodiments, those operators are part of separate entities.

The secondary treated sewage flowing from plant 76 flows through channels 120 in the direction of arrows 135 and 136. As the volume of ponds 115 and 116 is about 40% of the total collective volume of ponds 115, 116, 117 and 118, about 40% of the sewage is caused to flow in the direction of arrow 136, and the remainder in the direction of arrow 135. Of the 40% that flows into pond 115, about one half of that flows into subdivision 121, with the remainder flowing into subdivision 122. Similar flows are established for pond 117, albeit with three subdivisions 125, 126 and 127. Accordingly, each of the subdivisions 121, 122, 125, 126 and 127 receive about 20% of the sewage flowing from plant 76.

The sewage flow through subdivision 121 and 122 progresses to subdivisions 123 and 124 respectively via intermediate connecting channels. Similarly, the sewage flow through subdivision 125, 126 and 127 progresses to subdivisions 128, 129 and 130 respectively through further intermediate connecting channels. In other embodiments, the flows are structured otherwise. For example, in another embodiment, the flow through subdivisions 121 and 122 is combined, mixed, and split to flow through subdivisions 123 and 124.

The initial flow of sewage into the ponds is established, in this embodiment, in proportion to the volume of the ponds through which the sewage is to pass. For example, the combined volume of ponds 115 and 116 forms about 40% of the total volume of all the ponds and, as such, about 40% of the sewage is passed through ponds 115 and then pond 116. Moreover, as the subdivisions within those ponds are also substantially equal, the flow of sewage through those subdivisions is also maintained in substantial proportion to those relative volumes.

In other embodiments where the volume of the subdivisions are not equal, the flow is preferentially established to ensure the flow of sewage from plant 76 to the ponds is in proportion to the percentage of the total volume of the ponds. However, in further embodiments alternative or non-proportional flows of sewage are established. For example, to gain preferential growth rates in a give subdivision, or to accommodate different species of animals disposed within different subdivisions.

The further treated sewage emerges from ponds 116 and 118 and progresses along channels 137, in the direction of arrows 138 and 139, to a DAFF plant 140. Thereafter, the treated sewage flows through an outlet 141 and is returned to the environment. Typically, the release from outlet 141 is to a river, ocean or other body of water. In some instances, the body of water is for irrigation.

The flow of sewage through ponds 115, 116, 117 and 118 is continuous, and the dwell time of sewage between channel 120 and 137 is about sixteen days. In other embodiments the dwell time is a different number of days.

In FIG. 9 the directional flow of sewage in the subdivisions is represented by the respective arrows 142 in those subdivisions. It will be appreciated that the flow through the subdivisions is substantially longitudinal. In other embodiments, alternative flow patterns are used. Further embodiments use deflectors and other devices to create minor turbulence in the subdivisions to aid aeration of the sewage.

Containers 101 are initially placed in the desired subdivision and submerged. Following that, gate 105 is unlatched, and cage 110 drawn from the container and allowed to sit on the bottom of the subdivision. The cage, however, remains closed to provide the animals with time to acclimatise to the subdivision, and to commence feeding on the secondary treated sewage and other protein sources within the sewage. That is, the animals, while placed within the subdivision, are maintained a given distance below the surface of the water in that subdivision.

In those embodiments where substantive numbers of seabirds are in the vicinity of the ponds, the fingerlings remain in the cage for about ten days to best protect against animal losses due to poaching by the birds. After about this length of time in the cage, the animals are more likely to avoid approaching the surface of the water.

As mentioned above, in some embodiments, the transportation of the animals between hatchery 72 and ponds 73 is by way of fish carrier. In these embodiments, the ponds include separate cages that are continuously disposed within respective ponds and into which the animals are pumped from the carrier to affect their initial placement in the ponds. These separate cages are, like the cages described above, opened after some time to allow the animals to move freely about the respective subdivision.

The ponds are stocked with the number of animals that will, at the projected date that the harvest is to occur, constitute about the target biomass for that subdivision. The target biomass is determined in accordance with one or more predicted factors, including prevailing climatic conditions, historic and current measured nutrient levels, the length of the predetermined period, and the position of the subdivision in the flow of sewage from plant 76. This last factor is due to the general reduction in the nutrient level of the sewage as it progresses through the subdivisions and to plant 140. For example, the nutrient level in subdivision 121 is generally greater than that within the downstream subdivision 123 due to the animals in subdivision 121 having already consumed some of the available nutrient. The difference is not as great as may be thought due to the progressive growth in the sewage—subsequent to the sewage progressing from plant 76—of light algae and phytoplankton.

In the above embodiment, where each subdivision is about 35 Hectares and has an average depth of about 1.5 metres, about 2 million animals are placed in each subdivision at the time of placement. These animals are collectively held within a plurality of containers 101 that are initially placed in a given subdivision and the cages removed from the containers. Preferably, the respective cages are spaced apart transversely across the given subdivision to best ensure that all the cages are exposed to as nutrient rich a sewage flow as possible. Once the fingerlings are released from the cages they intermix across the entirety of the respective subdivision.

It has been found that the fingerlings referred to above, when placed in sub-divisions through which secondary sewage flows, grow at an average rate of about 8 grams/day over the initial forty two day period. This is achieved without any additional feeding of the animals. It will be appreciated that during the initial days the rate of growth is higher.

It has also been found that when the same fingerlings, when left within the same environment for about seventy seven days, experience an average growth rate is about 5 grams/day. That is, the fingerlings that enter the pond weighing an average of 20 grams, weigh about 400 grams when harvested after the predetermined period. This equates to about 780 tonnes of animals being harvested from each subdivision. In other embodiments the animals remain in the subdivisions for longer, or until their average weight is a different value to that specified above. In those embodiments where the biomass is other than 15 tonnes—as it is for the present embodiment —the number of animals initially placed in a given subdivision will be lower, and the harvest weight corresponding lower.

It will be appreciated by the skilled addressee that the rate of growth of the animals in the subdivisions will be dependent upon other factors such as the nutrient quality of the sewage, the temperature of the water, and the breed of the animal, amongst other things.

Once the animals reach a certain size their growth rates begin to plateau. Accordingly, to avoid a diminishing return on the tonnage of animal harvested from ponds 73, the harvesting is scheduled after the predetermined period following placement of the animals in the respective subdivisions. In other embodiments, one or more samples are periodically taken from each subdivision to gain an indicative average weight for the animals within that subdivision. In this case, the harvesting is scheduled when the measured weight has reached a desired benchmark.

Some sewage treatment processes have a secondary effect of making conditions favourable for plankton and/or light algae growth within the sewage that is discharged into the maturation ponds. While this has often been seen previously as disadvantageous—as it required a longer maturation time for the sewage—when applied to the present embodiments it is welcomed as a source of additional protein for the animals to consume and process.

In broad terms, the sewage that flows into the ponds contains minute solid or semi-solid particles that congeal to form sites for the growth of phytoplankton. In turn, the presence of phytoplankton encourages the growth of zooplankton, which feed on the former. It has been found that the animals used in the embodiments consume these naturally occurring phytoplankton and zooplankton.

As the animals are contained within respective subdivisions, the harvesting occurs continuously through progressive and sequential harvesting of animals from the subdivisions across the entirety of the pond or ponds. This assists in containing both the labour costs and the capital costs of operating ponds 73.

The harvesting of the animals occurs about seventy seven days after the initial placement of those same animals in the respective subdivisions, which is about 154 days—that is, two predetermined periods—following the hatching of the corresponding animals from eggs. As mentioned above, in other embodiments, alternative predetermined periods are used.

Each of the subdivisions includes a net (not shown) that extends transversely across that subdivision and which is, at the time of harvest of that subdivision, progressed longitudinally to concentrate the animals at one end of the subdivision. These animals are then pumped into a transportation vehicle that, in this embodiment, comprises one or more trucks. The trucks have load bays that support one or more stainless steel containers into which the animals are pumped. Simultaneously, a slurry of flow ice is pumped into the container to anaesthetise the animals and to minimise the risk of bruising and other damage.

The fingerlings placed in the respective subdivision will have grown over the predetermined period from about 20 grams on average to about 400 grams on average. Accordingly, as just under 2 million animals are harvested from a subdivision, the animal weight harvest is typically about 780 tonnes. While in a loss-less system it would have been expected to harvest about 800 tonnes—given the initial numbers of animals placed in the subdivision—it has been found in practice that losses do occur. For example, one form of animal loss is due to natural means such as illness and being consumed by other animals. Other losses include poaching by birds and other predators, while other losses include those animals that escape the harvesting nets. The extent of the losses will be dependent upon the robustness of the species of animal, the treatment applied to the sewage, and the susceptibility to and barriers employed against poaching, amongst other things such as effectiveness of net maintenance and the like.

ONCE THE LOAD BAY OF A TRUCK IS FILLED TO THE DESIRED LEVEL IT IS COVERED AND THE TRUCK PROGRESSES TO PLANT 74. IN THIS EMBODIMENT, THE DISTANCE BETWEEN PONDS 73 and plant 74 is less than 10 km. However, in other embodiments, the distance is more or less than 10 km.

In this embodiment the harvesting occurs as the need for the animals arises at plant 74. This ensures that the animals remain alive until required for processing. As mentioned above, the production cycle in plant 74 is aligned with an integral multiple of the predetermined period to ensure a close match of demand for animals and the availability of those animals from pond 73. However, in other embodiments, there is some storage or stockpiling of the animals at plant 74 prior to the subsequent processing of those animals. Where stockpiling occurs, the carcasses of the animals are placed in cold storage. In still further embodiments, the animals remain within the ponds for longer than the predetermined period so that the animals are, in effect, stored “live”. The preferred embodiments retain the animals in the ponds until required for processing at plant 74 to obviate or avoid the need for stockpiling prior to processing.

As best illustrated in FIG. 10, upon arriving at plant 74 the trucks tip the animals onto a hopper 151 which, in turn, feeds the animals whole onto a continuous mesh conveyor 152. This conveyor progresses the animals to a processing station 153 that segments, cooks and grinds the animals in a continuous and single operation.

Station 153 includes a large cylindrical steel container (not shown) that axially extends between two ends. The container defines a generally cylindrical continuous cavity having an opening at one of the ends for receiving the animals from conveyor 152 and an outlet at the other of the ends through which the processed animal carcasses are ejected from the station. The container is heated and includes a centrally mounted screw conveyor that rotates for axially progressing the carcasses from the inlet to the outlet. The screw action of the screw conveyor segments the carcases via a shearing action between the conveyor and the adjacent container. Segmentation also occurs due to frictional loading between carcasses. Simultaneously, the carcasses are heated to reduce the moisture content and to cook the carcasses. This combination of temperature and pressure and the shearing forces is carefully monitored to prevent the contents of station 153 from combusting.

Once the carcasses emerge from the outlet of station 153 they are progressed via an intermediate conveyor 154 to a press 155. Conveyor 154 is of the open mesh type and progresses slowly to allow time for the processed carcasses to cool. In some embodiments ventilating air is forced past the processed carcasses and through the open mesh of the conveyor to assist with the cooling.

Press 155 extrudes the processed carcasses into pellets, which are then passed through a dryer 156 to reduce moisture content of the pellets to less than about 30%, and more preferably to less than about 15%. In the preferred embodiment, the moisture content of the pellets is less than about 12% to contribute to a long shelf life for the pellets.

The pelletised fishmeal emerging from dryer 156 is referred to as unprocessed fishmeal, in that it is constituted of fish only. In some embodiments, no further processing of this fishmeal occurs other than to be packaged and transported for sale, consumption or application. However, in other embodiments, the unprocessed fishmeal is subject to further processing prior to such sale/consumption/application. This further processing, in this embodiment, includes combining the unprocessed fishmeal with other additives in predetermined proportion. By way of example, the end product being sought in this embodiment is a processed fishmeal for feeding aqua-culturally raised salmon. The processed fishmeal is produced by feeding the unprocessed fishmeal to a large volume rotary blender 157, together with the required additives, where the blending and mixing occurs.

In some embodiments, there is a pre-blending step of increasing the moisture content of the unprocessed fishmeal to assist with the blending. However, more typically, the moisture content is increased due to the moisture content of the additives. Moreover, following the blending, there is typically a drying step to bring the moisture content of the processed fishmeal to a desire level.

For the specific case of the processed fishmeal for the aqua-culturally raised salmon, the final content includes 66% by weight of unprocessed fishmeal, with the reminder being comprised of selected additives. The additives include soybean meal (17% by weight), and a ground bread and biscuit mix (17% by weight). In other embodiments, the bread and biscuit mix is substituted with another additive such as wheat, barley or other coarse grains, or a meal including such grains. It will be appreciated by those skilled in the art that other additives, in the same or different proportions, are used in other embodiments.

The separate individual additives are produced in batches to provide a relatively homogenous product for that batch.

In some embodiments, following the mixing of the additives with the unprocessed fishmeal, the processed fishmeal is passed to a further pellet press (not shown).

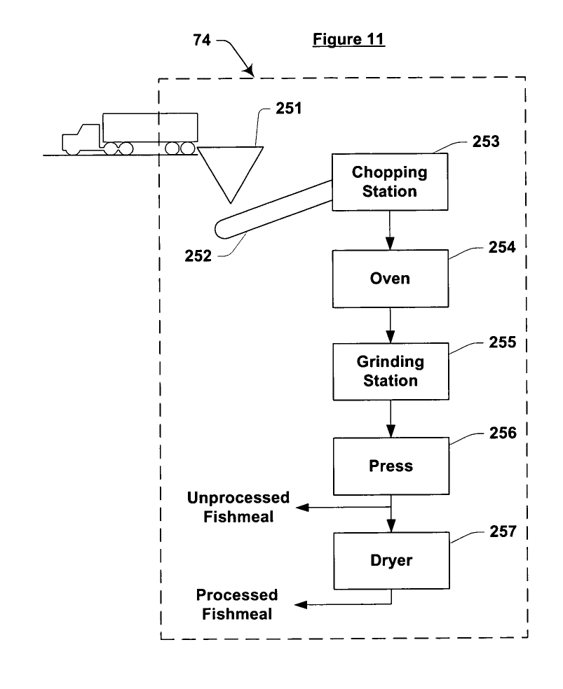

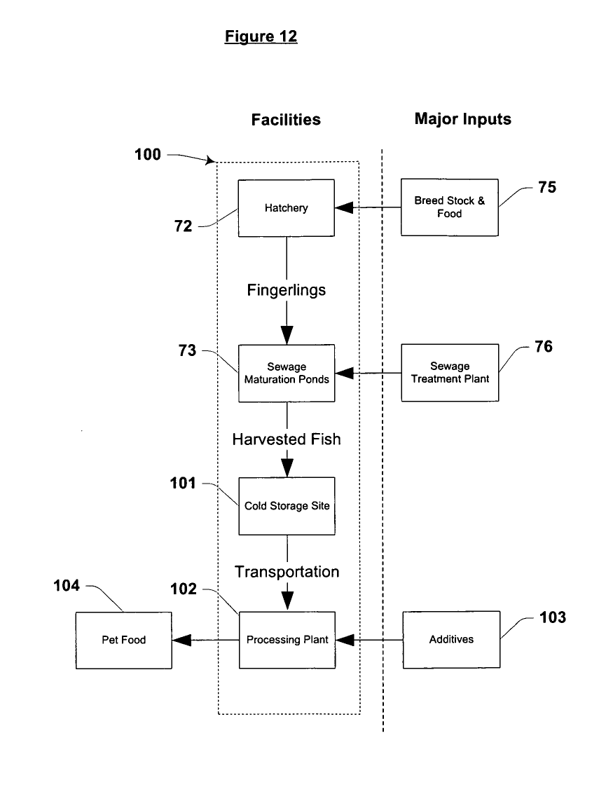

An alternative embodiment of plant 74 is schematically illustrated in FIG. 11. Upon arriving at plant 74 the trucks tip the animals onto a hopper 251 which, in turn, feeds the animals whole onto a continuous mesh conveyor 252. This conveyor progresses the animals to a segmenting station 253 where they are chopped roughly into pieces having an area of about 10 mm×10 mm. The third dimension of the pieces is determined by the orientation of the animal on the surface where the chopping occurs. Accordingly, there is considerably variation of that dimension depending upon whether the animal concerned lies, in one extreme, flat on the surface or, in the other extreme, is maintained in a generally upright configuration. The latter typically results from the animal being wedged against other adjacent animals on the surface.

In other embodiments, the segmentation results in pieces of different dimensions. For example, in one embodiment, the segmentation includes a plurality of chopping actions with intermediate agitation of the pieces to ensure a substantially random orientation of those pieces for the following cutting action.

The chopping station includes:
A chamber (not shown) having a substantially planar base for defining the cutting surface.
An opening through which the animals are progressed into the chamber and onto the cutting surface.
A plurality of cleaving blades for moving toward the surface and into cutting engagement with the animals, where the blades are normal to each other.

In other embodiments, the chamber includes a plurality of cleaving blades arranged in two sets, the blades in each set being substantially parallel and spaced apart by about 10 mm from one or more adjacent blades in that set, and the blades in one of the sets being substantially normal to the blades in the other of the sets.

The chopped pieces are transported from station 253 by an intermediate continuous conveyor (not shown) to an oven 254 where the pieces are dried and cooked. In this embodiment the cooking occurs through steam cooking, and is performed in a substantially sealed chamber to allow the use of greater than atmospheric pressures in that cooking process. In other embodiments, however, use is made of heated air that is circulated about the pieces, while in further embodiments alternative drying and cooking processes are used. Examples of such alternative methods include microwave energy, infrared energy, and more simple kiln based ovens.

The function of the oven in this embodiment is to both reduce the moisture content of the pieces and to kill pathogens and other undesirable life forms that may be contained within the pieces.

Once the pieces emerge from the oven they are progressed via a further intermediate conveyor (not shown) to a grinding station 255. This further intermediate conveyor is of the open mesh type and progresses slowly to allow time for the pieces to cool. In some embodiments ventilating air is forced past the pieces and through the open mesh of the conveyor to assist in the cooling of the pieces.

Station 255 is used to further segment the pieces, and includes a screw type grinding device (not shown) that grinds the pieces into small pieces of varying sizes. The small pieces emerge from the exit port of the grinding device having varying sizes. The variance is typically in the area of the pieces, while the thickness is more uniform at less than about 1 mm. This is due to the operation of a helical grinding screw used in the grinding device that rotates axially to not only shear the carcasses, but also to progress the carcasses/pieces toward the exit port.

In some embodiments, the oven and grinding device are combined in a single housing.

The small shredded pieces from the grinding device are passed to a press 256 and subsequently extruded to form pellets of unprocessed fishmeal. The pellets are then dried to reduce their moisture content to less than about 30%, and more preferably to less than about 15%. In the preferred embodiment, the moisture content of the pellets is less than about 12% to contribute to a long shelf life for the pellets of unprocessed fishmeal.

As with the FIG. 10 embodiment, the unprocessed fishmeal is, where required, combined with additives to produce processed fishmeal.

Accordingly, the three main applications of the harvested fish in the preferred embodiments of the invention, as presently envisaged, are:
1. As a base ingredient in manufacturing aqua-cultural products;
2. As a base ingredient in manufacturing agricultural products; and
3. After appropriate quality testing, for human consumption.

The use of the fish as a base for aqua-cultural products provides a quick growth, high protein meal. Moreover, the ease at which additives are accommodated into the manufacturing process allows the customer to quickly and conveniently tailor the meal to the required task. Similar comments apply to the use of the fish as a base ingredient for agricultural products, as the requirements for pig feed will be substantially different to that of a soil fertiliser.

The preferred embodiments of the invention provide a systematic and environmentally sustainable means of treatment of sewage as well as a method of producing fishmeal in a cost effective and resource effective manner.

A further embodiment of the invention, in the form of a system 100 for producing pet food from sewage, is illustrated schematically in FIG. 12, where corresponding features are denoted by corresponding reference numerals. In this embodiment, once the fish are removed from the maturation ponds they are immediately transported to a cold storage site 101 that is disposed adjacent to ponds 73. At site 101 the fish are frozen and stored temporarily until transported to a remote processing plant 102.

In other embodiments, the cold storage site is a container into which the harvested fish are pumped, together with a slurry of flow ice. These containers are then transported to a remote plant 102. Preferably, the containers are insulated.

It will be appreciated that in this embodiment the fish, in their entirety, are frozen and stored at site 101. This occurs when the requirements of plant 102 is for whole fish (referred to as “WF form”). However, in other embodiments, plant 102 has a requirement for other forms, and this is also accommodated. For example, if the requirements of plant 102 are for hog form—that is, the fish having being gutted and having their heads left on—the gutting of the fish occurs at site 101 prior to the cold storage of the remainder of the fish carcasses. The removed material is retained and provided, for example, to plant 74 for inclusion within fishmeal.

The gutting of the fish in this embodiment is mechanised.

Plant 102 processes the frozen fish carcasses and any other additives required, to produce food for animals such as domesticated pets. While this embodiment is intended primarily for the production of food for domesticated cats, it is also suitable for other animals such as domesticated dogs and other carnivorous animals.

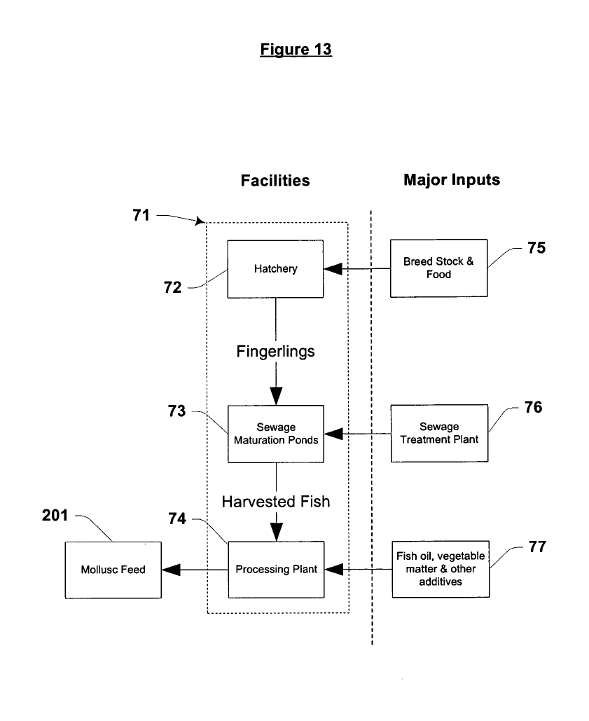

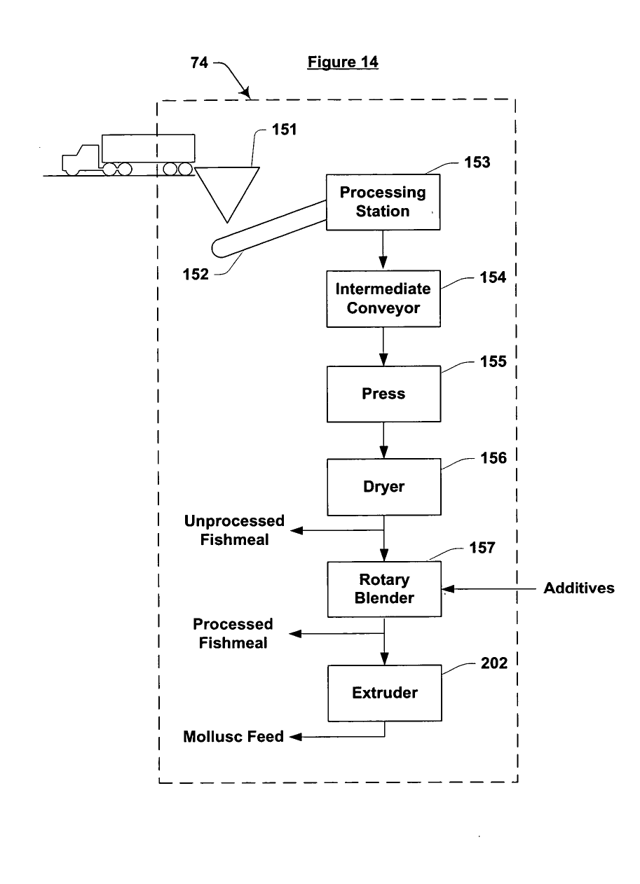

A further embodiment of the invention, in the form of a system 200 for producing mollusc feed 201 from sewage, is illustrated schematically in FIGS. 13 and 14. In these figures corresponding features are denoted by corresponding reference numerals. Referring particularly to FIG. 14, the pelletised fishmeal emerging from dryer 156, referred to as unprocessed fishmeal, is subject to further processing prior to its sale/consumption/application as mollusc feed. This further processing, in this embodiment, includes combining the unprocessed fishmeal with additives in predetermined proportion. Processed fishmeal is produced by feeding the unprocessed fishmeal to a large volume rotary blender 157, together with the required additives, where the blending and mixing occurs.

In an alternate embodiment, press 155 and dryer 156 are bypassed such that the animal carcasses are fed directly from intermediate conveyor 154 to rotary blender 157. In this embodiment the substance being transported by intermediate conveyor 154 is referred to as unprocessed fishmeal.

In some embodiments, there is a pre-blending step of increasing the moisture content of the unprocessed fishmeal to assist with the blending. However, more typically, the moisture content is increased due to the moisture content of the additives. Moreover, following the blending, there is typically a drying step to bring the moisture content of the processed fishmeal to a desired level.

The additives, in this embodiment, include vegetable matter, such as cabbage. The vegetable matter is added in a predetermined proportion to reduce the final protein content of the feed. In one embodiment, wherein the feed is for consumption by abalone, the final mollusc feed includes about 68% by weight of vegetable matter. In other embodiments alternate proportions of vegetable matter are used, preferably selected on account of the metabolic properties of the molluscs by which the feed is to be consumed and the desired growth rates.

In some embodiments, the additives include an artificial or natural essence for increasing the palatability of the feed as perceived by the molluscs by which the feed is to be consumed. In one embodiment, wherein the feed is for consumption by abalone, an artificial essence of red seaweed is used. In other embodiments, the essence is preferably chosen by reference to the natural food source of the molluscs by which the feed is to be consumed.

In some embodiments, the additives include one or a variety of fish oils. The fish oil is chosen with reference to the metabolic properties of the molluscs by which the feed is to be consumed, and preferably contains a high count of long chain polyunsaturated fatty acids. Such fish oils include mackerel oil and cod liver oil.

In some embodiments, the additives include a binding element to delay break-up of the feed in water. It will be appreciated by those skilled in the art that in other embodiments more than one binding element is used.

In some embodiments, further steps are taken to control the lipid content of the feed. Preferably, this is achieved through the selection of additives, but in some embodiments requires a further processing step.

In a specific embodiment, wherein the feed is for consumption by blacklip abalone, the final content includes about 22.2% by weight of unprocessed fishmeal, and less than about 4% by weight of lipids. The remainder of the feed comprises vegetable matter, fish oil and essence of red seaweed. It will be appreciated by those skilled in the art that other additives, in the same or different proportions, are used in other embodiments.

The separate individual additives are produced in batches to provide a relatively homogenous product for that batch.

Following the mixing of the additives with the unprocessed fishmeal, the processed fishmeal is passed to an extruder 202 where it is extruded under a relatively high pressure to form mollusc feed having a predetermined density which is preferably higher than the density of water. The particular predetermined density is preferably selected with reference to the eating habits and location of the molluscs by which the feed is to be consumed. For example, if the feed is to be consumed by abalone contained in raceways within a grow-out facility, the predetermined density is the density of water flowing in the raceways.

Extruder 202 is controlled to maintain a consistent pressure when producing a given batch of feed. However, extruder 202 is also adjustable to maintain different pressures between different batches. It will be appreciated by those skilled in the art that an extruder, such as extruder 202, will typically give a better control of the pressure than, say, a pelletising press. Accordingly, use of an extruder allows better control over the ultimate density of the feed.

It will be appreciated by those skilled in the art that, in other embodiments, devices other than extruders are used to exert a relatively high pressure on the processed fishmeal to form the feed.

It is preferable that the step of extrusion is conducted in such a manner as to minimise the rate at which the mollusc feed will break down in water. This is achieved by configuring press 202 for extruding substantially planar tape portions rather than substantially cylindrical pellets.

The invention has been developed primarily for use with sewage comprised of human waste and has been described herein with reference to that application. However, we appreciate that the invention is not limited to that particular field of use and is also applicable to the processing of sewage including animal waste and other organic waste.

Although the invention has been described with reference to specific examples, it will be appreciated by those skilled in the art that it may be embodied in many other forms.

1. A method for producing fishmeal from sewage, the method comprising the steps of:
introducing the sewage into a holding tank;
releasing live fish into the holding tank to consume and process the sewage;
removing the fish from the holding tank; and
processing the fish to produce the fishmeal, wherein the processing step includes the substeps of:
segmenting the fish into pieces;
drying the fish; and
combining the pieces with additives to form one of a paste and a powder.

2. A method according to claim 1, wherein the substep of segmenting includes one or more of: cutting the fish into the pieces; grinding the fish into pieces; and shredding the fish into pieces.

3. A method according to claim 1, wherein the substep of drying the fish includes cooking the fish.

4. A method according to claim 1, wherein the moisture content of the paste is about 10% to 15%.

5. A method according to claim 4, wherein the moisture content of the paste is about 11% to 13%.

6. A method according to claim 1, wherein one of the paste and the powder is extruded into pellets and wherein, prior to the extruding, the moisture content is varied by one of (i) addition of water to one of the paste and the powder and (ii) drying one of the paste and the powder.

7. A method according to claim 1, wherein the pieces of fish are less than or about 1 cm³.

8. A method according to claim 1, wherein the combining of the pieces of fish with the additives includes agitating the pieces of fish both to encourage intermingling of the pieces with the additives and to further break down the pieces into smaller pieces.

9. A method for treating sewage, comprising the steps of:
processing the sewage with a primary or secondary sewage treatment;
directing the processed sewage into a holding tank;
releasing live fish into the holding tank to consume and otherwise process the sewage; and
removing the fish from the tank.

10. A method according to claim 9, wherein the fish are removed from the tank at a predetermined period after being released into the tank.

11. A method according to claim 9, wherein the fish are removed from the tank when they are of one of a predetermined size and a predetermined weight.

12. A method according to claim 10, wherein the fish are European carp and the predetermined period is within the range of about seventy days to ninety days.

13. A method according to claim 12, wherein the predetermined period is within the range of about seventy five to eighty days.

14. A method according to claim 9, wherein the holding tank includes a plurality of sub-divisions through which the sewage is directed, and wherein the method further comprising the step of:
releasing live fish into each sub-division and subsequently harvesting the live fish from respective sub-divisions.

15. A method for producing fishmeal from sewage, the method comprising the steps of:
growing over a predetermined period a given biomass of live fingerlings;
introducing the sewage into a holding tank;
releasing the fingerlings into the holding tank to consume and process the sewage and to grow into fish;
removing the fish from the holding tank after about at least one integral multiples of the predetermined period following their release into the tank; and
processing the fish to produce the fishmeal.

16. A method according to claim 15, wherein the fish are removed from the holding tank after about one predetermined period.

17. A method for producing pet food from sewage, the method comprising the steps of:
introducing the sewage into a holding tank;
releasing live fish into the holding tank to consume and process the sewage;
removing the fish from the holding tank;
freezing the fish; and
processing the fish to produce the pet food.

18. A method for according to claim 17, wherein the live fish, upon release into the holding tank, are fingerlings.

19. A method according to claim 18, further comprising the step of:
growing over a predetermined period a given biomass of the fingerlings.

20. A method according to claim 19, wherein the step of removing the fish from the holding tank occurs after about the at least one integral multiples of the predetermined period following their release into the tank.

21. Pet food derived from the method according to claim 17.

22. A method for producing mollusc feed from sewage, the method comprising the steps of:
introducing the sewage into a holding tank;
releasing live fish into the holding tank to consume and process the sewage;
removing the fish from the holding tank;
processing the fish to produce fishmeal; and
processing the fishmeal to produce mollusc feed.

23. A method for according to claim 22, wherein the live fish, upon release into the holding tank, are fingerlings.

24. A method according to claim 23, further comprising the step of:
growing over a predetermined period a given biomass of the fingerlings.

25. A method according to claim 24, wherein the step of removing the fish from the holding tank occurs after about at least one integral multiples of the predetermined period following their release into the tank.

26. A method according to claim 22, wherein the step of processing the fishmeal comprises the substeps of:
combining the fishmeal with additives to produce an intermediate product;
controlling the moisture content of the intermediate product; and
extruding the intermediate product to produce mollusc feed having a density higher than a predetermined density.

27. A method according to claim 26, wherein the predetermined density is the density of water.

28. A method according to claim 26, wherein the feed is for consumption by molluscs contained in a liquid and the predetermined density is the density of the liquid.

29. Mollusc feed derived from the method according to claim 22.
